(19) United States
(12) Patent Application Publication
(10) Pub. No.: US 2016/0203192 A1
(43) Pub. Date: Jul. 14, 2016

(54) MODIFYING RECIPES TO REDUCE PREPARATION TIMES AND/OR INCORPORATE PREFERRED INGREDIENTS

(71) Applicant: INTERNATIONAL BUSINESS MACHINES CORPORATION, ARMONK, NY (US)

(72) Inventors: DEBARUN BHATTACHARJYA, NEW YORK, NY (US); FLORIAN PINEL, NEW YORK, NY (US); NAN SHAO, RIDGEFIELD, CT (US)

(73) Assignee: INTERNATIONAL BUSINESS MACHINES CORPORATION, ARMONK, NY (US)

(21) Appl. No.: 15/080,179

(22) Filed: Mar. 24, 2016

Related U.S. Application Data
(63) Continuation of application No. 14/572,972, filed on Dec. 17, 2014.

(51) Int. Cl. G06F 17/30

(52) U.S. Cl. CPC G06F 17/30528; G06F 17/30448

(57) ABSTRACT

A technique for modifying food recipes includes parsing a target recipe into recipe components. Existing recipes that are similar to the target recipe are located. Each of the existing recipes is modified to include ingredients of the target recipe. Respective modification criteria for each of the modified existing recipes is determined. A substitute recipe for the target recipe is selected from the modified existing recipes based on the respective modification criteria.

### BACKGROUND

The present disclosure is generally directed to modifying recipes and, more specifically, to techniques for modifying recipes to reduce preparation times and/or incorporate preferred ingredients.

Watson was originally designed as a question answering (QA) system (i.e., a data processing system) that applied advanced natural language processing, information retrieval, knowledge representation, automated reasoning, and machine learning technologies to the field of open domain question answering. In general, document search technology receives a keyword query and returns a list of documents, ranked in order of relevance to the query (often based on popularity and page ranking). In contrast, QA technology receives a question expressed in natural language, seeks to understand the question in greater detail than document search technology, and returns a precise answer to the question.

The original Watson system reportedly employed more than one-hundred different algorithms to analyze natural language, identify sources, find and generate hypotheses, find and score evidence, and merge and rank hypotheses. The original Watson system implemented DeepQA™ software and the Apache™ unstructured information management architecture (UIMA) framework. Software for the original Watson system was written in various languages, including Java, C++, and Prolog, and runs on the SUSE™ Linux Enterprise Server 11 operating system using the Apache Hadoop™ framework to provide distributed computing. As is known, Apache Hadoop is an open-source software framework for storage and large-scale processing of datasets on clusters of commodity hardware.

The original Watson system employed DeepQA software to generate hypotheses, gather evidence (data), and analyze the gathered data. The original Watson system was workload optimized and integrated massively parallel POWER7® processors. The original Watson system included a cluster of ninety IBM Power 750 servers, each of which includes a 3.5 GHz POWER7 eight core processor, with four threads per core. In total, the original Watson system had 2,880 POWER7 processor cores and 16 terabytes of random access memory (RAM). Reportedly, the original Watson system could process 500 gigabytes, the equivalent of a million books, per second. Sources of information for the original Watson system included encyclopedias, dictionaries, thesauri, newswire articles, and literary works. The original Watson system also used databases, taxonomies, and ontologies.

### BRIEF SUMMARY

Disclosed are a method, a data processing system, and a computer program product (embodied in a computer-readable storage device) for modifying recipes to reduce preparation times and/or incorporate preferred ingredients.

A technique for modifying food recipes includes parsing a target recipe into recipe components (e.g., ingredient lists and instruction graphs). Existing recipes that are similar to the target recipe are located. Each of the existing recipes is modified to include ingredients of the target recipe. Respective modification criteria (e.g., one or more of reduced preparation time, improved quality, ingredient availability, reduced cost, increased rating, higher nutrition, and novelty) for each of the modified existing recipes is determined. A substitute recipe for the target recipe is selected from the modified existing recipes based on the respective modification criteria.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein:

FIG. 1 is a diagram of an exemplary high performance computing (HPC) cluster that includes a number of nodes, with one or more of the nodes including multiple processors that are configured to modify recipes to reduce preparation times and/or incorporate preferred ingredients according to one or more aspects of the present disclosure;

FIG. 2 is a diagram of a relevant portion of an exemplary symmetric multiprocessor (SMP) data processing system included in one of the nodes of FIG. 1, according to an embodiment of the present disclosure;

FIG. 3 depicts relevant components of an exemplary recipe modification system pipeline;

FIG. 4 depicts relevant components of the exemplary recipe modification system pipeline in additional detail;

FIG. 5 depicts exemplary classes that include ingredients that may be selected to facilitate modifying recipes to reduce preparation times and/or incorporate preferred ingredients according to an embodiment of the present disclosure;

FIG. 6 depicts an exemplary instruction graph for a quiche recipe;

FIG. 7 depicts an exemplary instruction graph for the quiche recipe of FIG. 6 (with various substitute ingredients) that is modified based on a target recipe;

FIG. 8 depicts an exemplary instruction graph for the quiche recipe of FIG. 6 (with various substitute ingredients, a new ingredient, and a deleted ingredient) that is modified based on a target recipe; and

FIG. 9 is a flowchart of an exemplary process for modifying recipes to reduce preparation times and/or incorporate preferred ingredients, according to an embodiment of the present disclosure.

### DETAILED DESCRIPTION

The illustrative embodiments provide a method, a data processing system, and a computer program product (embodied in a computer-readable storage device) for modifying recipes to, for example, reduce preparation times and/or incorporate preferred ingredients.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized. As may be utilized herein, the term ‘coupled’ encompasses a direct electrical connection between components or devices and an indirect electrical connection between components or devices achieved using one or more intervening components or devices. As used herein, the terms ‘data’ and ‘evidence’ are interchangeable.

Conventionally, the Watson system has explored large amounts of structured and unstructured data to find candidate answers for a question (or a problem). According to various embodiments of the present disclosure, a Watson system may be modified to receive input other than questions. For example, in one or more embodiments, a Watson system is modified to receive a target recipe (that includes ingredients and possibly steps from a target recipe). Upon receipt of the target recipe, the modified Watson system (Chef Watson) is configured to locate one or more existing recipes that are similar to the target recipe and modify the existing recipes to include ingredients from the target recipe. Steps of the existing recipes may also be modified based on the target recipe and/or based on available knowledge on how a recipe ingredient is normally utilized. For example, if nutmeg is added to an existing quiche recipe, the nutmeg may be grated based on the target recipe or based on how nutmeg is normally utilized in existing quiche recipes. As another example, if salmon is substituted for lobster (which is normally shelled) in an existing recipe, the shell step would be removed from the existing recipe as salmon does not require shelling. Alternatively, a modified Watson system may modify the steps of a target recipe to conform to the steps of a selected existing recipe while employing the ingredients from the target recipe.

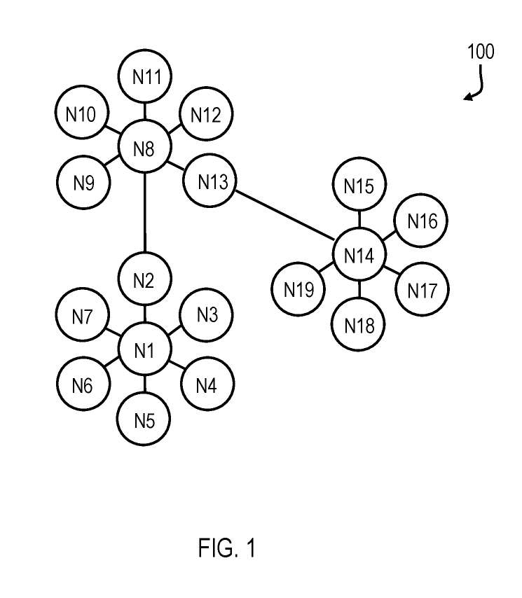

According to various aspects of the present disclosure, techniques for performing high performance computing (HPC) or network computing (using one or more nodes) is described herein that advantageously modify existing recipes to, for example, reduce preparation times and/or incorporate preferred ingredients based on a target recipe. As used herein, a ‘node’ may include one or more symmetric multiprocessors (SMPs). With reference to FIG. 1, an example topology for a relevant portion of an exemplary HPC cluster (supercomputer) 100 includes a number of nodes (N1-N18) that are connected in, for example, a three-dimensional (3D) Torus topology. While eighteen nodes are illustrated in FIG. 1, it should be appreciated that more or less than eighteen nodes may be present in an HPC cluster configured according to the present disclosure.

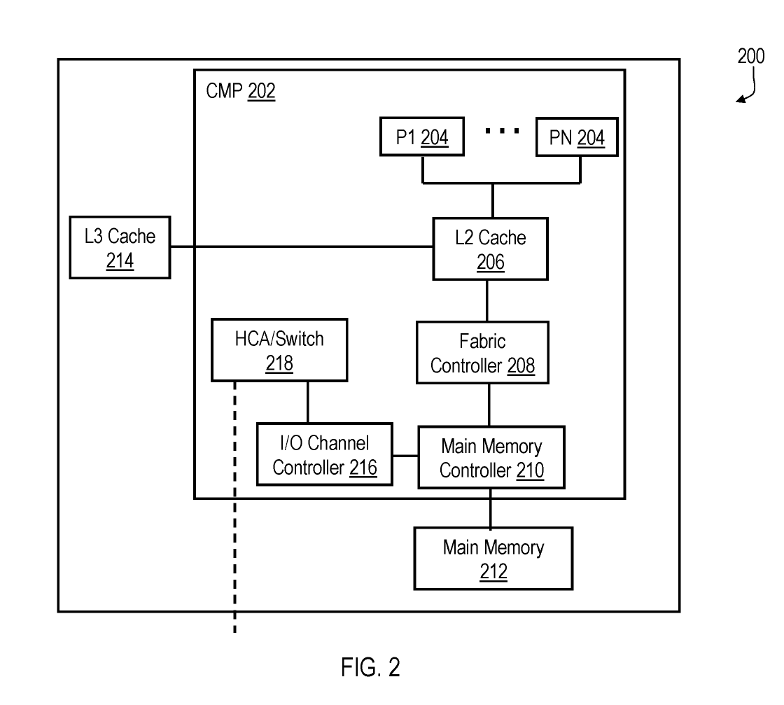

With reference to FIG. 2, each of the nodes N1-N18 of FIG. 1 may include a processor system, such as data processing system 200. As is illustrated, data processing system 200 includes one or more chip-level multiprocessors (CMPs) 202 (only one of which is illustrated in FIG. 2), each of which includes multiple (e.g., eight) processors 204. Processors 204 may, for example, operate in a simultaneous multithreading (SMT) mode or a single thread (ST) mode. When processors 204 operate in the SMT mode, processors 204 may employ multiple separate instruction fetch address registers to store program counters for multiple threads.

In at least one embodiment, processors 204 each include a first level (L1) cache (not separately shown in FIG. 2) that is coupled to a shared second level (L2) cache 206, which is in turn coupled to a shared third level (L3) cache 214. The L1, L2, and L3 caches may be combined instruction and data caches or correspond to separate instruction and data caches. In the illustrated embodiment, L2 cache 206 is further coupled to a fabric controller 208 that is coupled to a main memory controller (e.g., included in a Northbridge) 210, which supports a main memory subsystem 212 that, in various embodiments, includes an application appropriate amount of volatile and non-volatile memory. In alternative embodiments, fabric controller 208 may be omitted and, in this case, L2 cache 206 may be directly connected to main memory controller 210.

Fabric controller 208, when implemented, facilitates communication between different CMPs and between processors 204 and memory subsystem 212 and, in this manner, functions as an interface. As is further shown in FIG. 2, main memory controller 210 is also coupled to an I/O channel controller (e.g., included in a Southbridge) 216, which is coupled to a host channel adapter (HCA)/switch block 218. HCA/switch block 218 includes an HCA and one or more switches that may be utilized to couple CMP 202 to CMPs in other nodes (e.g., I/O subsystem nodes and processor nodes) of HPC cluster 100.

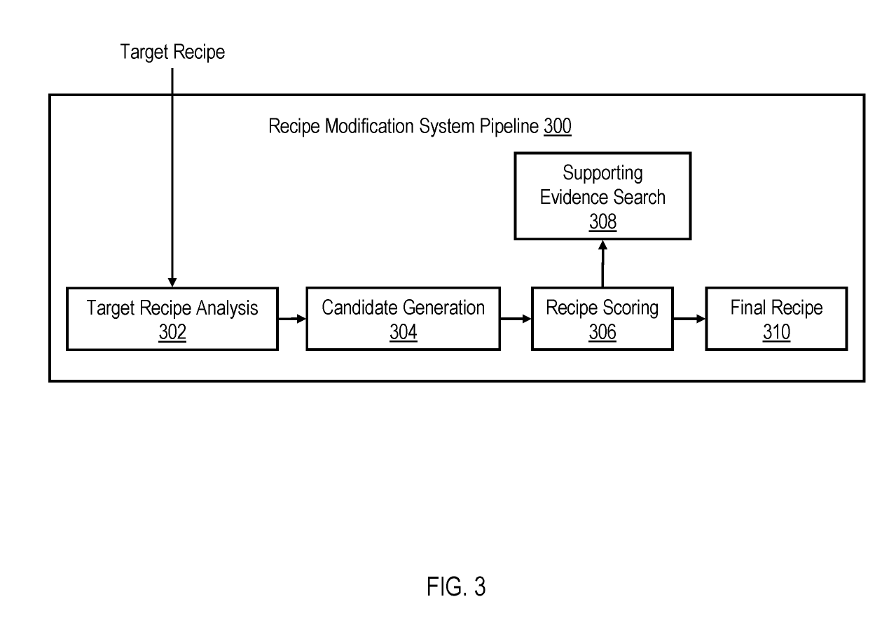

FIG. 3 illustrates relevant components of a recipe modification system pipeline 300 for an exemplary recipe modification system. As is illustrated in FIG. 3, a target recipe analysis block 302 of pipeline 300 receives input (e.g., in the form of a target recipe including target ingredients and target preparation steps) and generates an output representing its analysis of the target recipe. A candidate generation block 304 of pipeline 300 receives the output from recipe analysis block 302 at an input and generates candidate recipes. The candidate recipes are provided to an input of a recipe scoring block 306, which is configured to initiate a supporting evidence search (by supporting evidence search block 308) in order to score the various generated recipes. The results of the recipe scoring are provided to a final recipe block 310, which is configured to provide a final recipe based on the scoring of the candidate recipes. It should be appreciated that blocks 302-310 may be implemented in program code executing on one or more processor cores or may be directly implemented in dedicated hardware (logic).

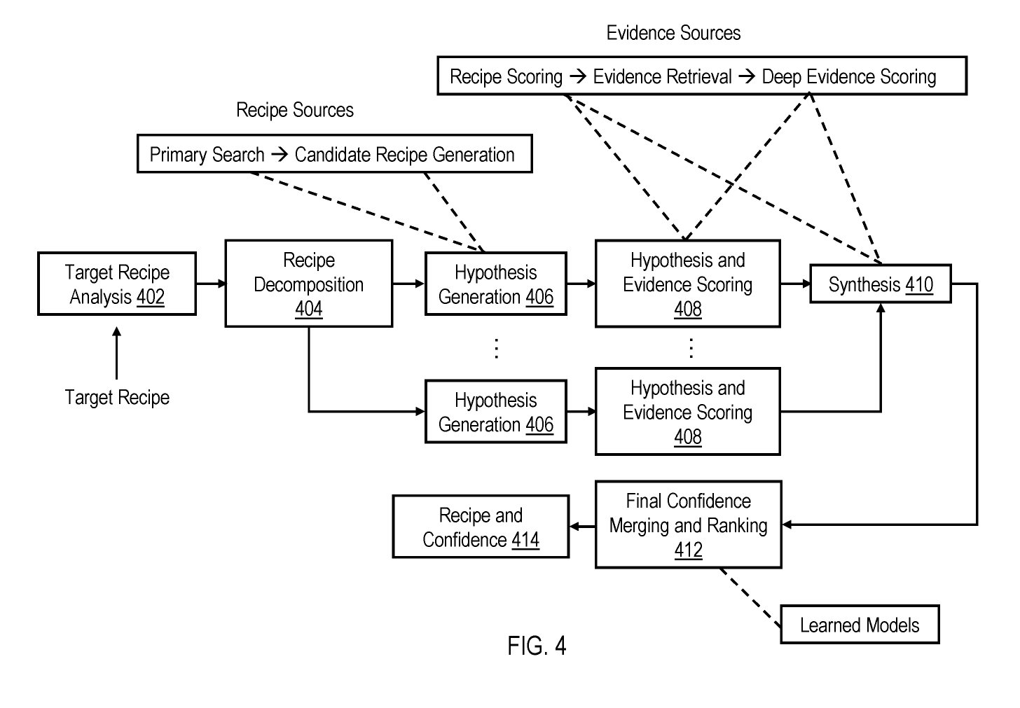

FIG. 4 illustrates relevant components of exemplary recipe modification system pipeline 300 in additional detail. As is illustrated, target recipe analysis block 402 receives a target recipe. An output of block 402 is provided to a recipe decomposition block 404, which further analyzes the recipe ingredients and steps. Block 404 provides inputs to multiple hypothesis generation blocks 406, which perform parallel hypothesis generation. Hypothesis generation blocks 406 each perform a primary search, collect reference data from different structured and unstructured sources, and generate candidate recipes. For example, data generated by hypothesis ‘i’ may be referenced as ‘D_i’, and data generated by hypothesis T may be referenced as ‘D_j’. The data ‘D_i’ and ‘D_j’ may be the same data, completely different data, or may include overlapping data.

As one example, a recipe modification system may be configured, according to the present disclosure, to: receive a target recipe; create ‘N’ hypotheses (1 . . . N) to find candidate recipes (e.g., N=10); and load data for each hypothesis T on which to operate into a shared cache. For example, assuming a shared cache across all hypotheses, 1/Nth of the shared cache may be loaded with data for each hypothesis to operate on. The recipe modification system may be further configured to execute the ‘N’ hypotheses to return ‘M’ candidate recipes (in this case, each hypothesis generates one or more candidate recipes). For example, the notation ‘ANS_i’ may be employed to denote a set of candidate recipes generated by hypothesis ‘i’. In various embodiments, hypothesis and evidence scoring for each hypothesis is initiated in hypothesis and evidence scoring blocks 408. That is, the recipe modification system is further configured to score all the candidate recipes using hypothesis and evidence scoring techniques (e.g., providing ‘M’ scores for ‘M’ candidate recipes). In synthesis block 410 the QA system evaluates the candidate recipes with the highest scores and determines which hypotheses generated the highest scores.

Following block 410, the recipe modification system initiates final confidence merging and ranking in block 412. Finally, in block 412, the recipe modification system provides a recipe (and may provide a confidence score) to replace the target recipe. Assuming, for example, the candidate recipes ‘i’, ‘k’, and ‘l’ have the highest scores, a determination may then be made as to which of the hypotheses generated the best candidate recipes. As one example, assume that hypotheses ‘c’ and ‘d’ generated the best candidate recipes ‘i’, ‘k’, and ‘l’. The recipe modification system may then upload additional data required by hypotheses ‘c’ and ‘d’ into the cache and unload data used by other hypotheses from the cache. According to the present disclosure, the priority of what data is uploaded is relative to candidate recipe scores (as such, hypotheses producing lower scores have less associated data in cache). When a new target recipe is received, the above-described process is repeated. If the hypotheses ‘c’ and ‘d’ again produce best candidate recipes, the recipe modification system loads more data that is relevant to the hypotheses ‘c’ and ‘d’ into the cache and unloads other data.

If, on the other hand, hypotheses ‘h’ and ‘g’ produce the best candidate recipes for the new target recipes, the recipe modification system loads more data relevant to the hypotheses ‘h’ and ‘g’ into the cache and unloads other data. It should be appreciated that, at this point, hypotheses ‘c’ and ‘d’ probably still have more data in the cache than other hypotheses, as more relevant data was previously loaded into the cache for the hypotheses ‘c’ and ‘d’. According to the present disclosure, the overall process repeats in the above-described manner by basically maintaining data in the cache that evidence scoring indicates is most useful. The disclosed process may be unique to a recipe modification system when a cache controller is coupled directly to an evidence scoring mechanism of a recipe modification system.

In general, people only try a fraction of recipes in cookbooks they own and/or magazines to which they subscribe. Home cooks often want to try a new recipe but are unable to do so, for example, because the home cooks: wish to prepare the dish faster than an estimated preparation time; do not have some required ingredients; and/or prefer to use specific ingredients (which they already have, are easy to obtain, are less expensive, and/or more nutritious, etc.). According to the present disclosure, techniques are disclosed that facilitate modifying recipe steps and/or ingredients in a recipe to potentially reduce preparation time, with minimal impact on the quality. According to one embodiment, a recipe is modified with the intention of reducing the preparation time and/or incorporating preferred ingredients. According to one aspect of the present disclosure, instead of modifying a target recipe per se, existing recipes that are similar to the target recipe are modified in an appropriate manner. The target recipe is then replaced with one of the modified existing recipes. For example, the target recipe may be replaced with the modified existing recipe that is the fastest to prepare, has the highest rating/quality, or a combination of these factors.

A dataset of recipes may, for example, include: ingredient proportions; instructions; preparation times; and ratings (if available). Ingredients may have associated nutritional facts that are utilized in determining appropriateness of substituting one ingredient for another ingredient in a recipe. In various embodiments, ingredients and recipes are grouped into classes (e.g., vegetable, fruit, meat, pizza dish, pasta dish, burrito dish, etc.). In one or more embodiments, each recipe is parsed into an ingredient list and an instruction graph. For example, an ingredient list for a quiche recipe may include: four ounces of mushrooms; one ounce of butter; three ounces of heavy cream; three eggs; two ounces of Swiss cheese; eight ounces of short crust; and four ounces of bacon.

According to at least one embodiment, a target recipe is parsed into an ingredient list and an instruction graph. Existing recipes similar to the target recipe are then located and potential ingredient substitutions may be optionally identified. Each existing recipe may then be modified to include ingredients from the target recipe. A new preparation time and a rating/quality for each of the modified existing recipes may then be determined. Based on the preparation time and the rating/quality a substitute recipe for the target recipe may then be selected. For example, a similar recipe may be located based on a dish type (e.g., pizza dish, pasta dish, burrito dish, etc.). As one example, Jaccard similarity coefficients may be utilized to determine similarity between existing recipes and a target recipe. As another example, an ingredient distance from a similar recipe to a target recipe may be computed to determine similarity. For example, an ingredient distance may be defined as an edit distance between ingredient sets of two recipes. Various operations (e.g., insertion, same-class substitution, deletion, etc.) can be defined and used to compute the ingredient distance. Existing recipes closest to the target recipe may then be retained for analysis. In one or more embodiments, ingredient substitutions of the same class in the target recipe (e.g., replace beef with chicken, use several vegetables (kale, spinach, and escarole) instead of a single vegetable (spinach only)) may be made when desirable (e.g., to reduce cost, increase quality, and/or reduce preparation time).

Ingredient similarity may, for example, be determined per U.S. patent application Ser. No. 14/458,315, which is incorporated herein by reference in its entirety for all purposes. The final set of ingredients associated with a target recipe may be denoted as target ingredients with an existing recipe being modified to include the target ingredients. Target ingredients that are not found in an existing recipe may be added by combining the ingredients with other ingredients of the same class (e.g., vegetable, fruit, meat, etc.). Ingredient classes can be further grouped into equivalence classes (e.g., a seafood class may be equivalent to a meat class). Ingredients in an existing recipe that are not found in a target recipe may be removed. For target ingredients that cannot be combined with other ingredients of the same class or of an equivalent class, other existing recipes may be examined to determine where the ingredient is typically inserted and how it is prepared before being inserted. Insertion points may, for example, be limited to recipe steps that receive more than one input ingredient (e.g., a ‘combine’ step). For example, ingredient proportions may be updated per U.S. patent application Ser. No. 14/459,903, which is incorporated herein by reference in its entirety for all purposes. A preparation time for each recipe step may be determined per U.S. patent application Ser. No. 13/834,937, which is incorporated herein by reference in its entirety for all purposes.

A preparation time of an existing recipe may be updated by: subtracting preparation time for steps that were removed; adding preparation time for steps that were added; and changing preparation time for steps that were modified. Various attributes of a new recipe can be measured, e.g., rating/quality (when relevant data is available), novelty, nutritional content, etc. When rating data is unavailable, the rating of a new recipe may be assumed to be the same as the rating of the existing recipe on which the new recipe is based. In another embodiment, a feature set can be defined for a recipe using ingredients, preparation methods, and nutrition, and a machine learning algorithm can be used to predict a rating based on the recipe features (see, for example, C.-Y. Teng, Y.-R. Lin, and L. A. Adamic, “Recipe recommendation using ingredient networks,” in Proc. 3rd Annu. ACM Web Sci. Conf. (WebSci'12), Jun. 2012, pp. 298-307.). Other attributes, such as quality and novelty, can be determined using the approach outlined in “L. R. Varshney, F. Pinel, K. R. Varshney, A. Schorgendorfer, and Y.-M. Chee, “Cognition as a part of computational creativity,” in Proceedings of the 12th IEEE International Conference on Cognitive Informatics and Cognitive Computing, July 2013.

A process may be employed to provide a list of existing recipes with the same or similar ingredients as a target recipe with associated preparation times and rating/quality (and possibly other attributes). A user can then choose between, for example, the recipe with: the lowest preparation time; the highest rating/quality; and/or a compromise between any set of attributes. It should be appreciated that the disclosed techniques are applicable to other domains, e.g., manufacturing processes, business processes, etc.

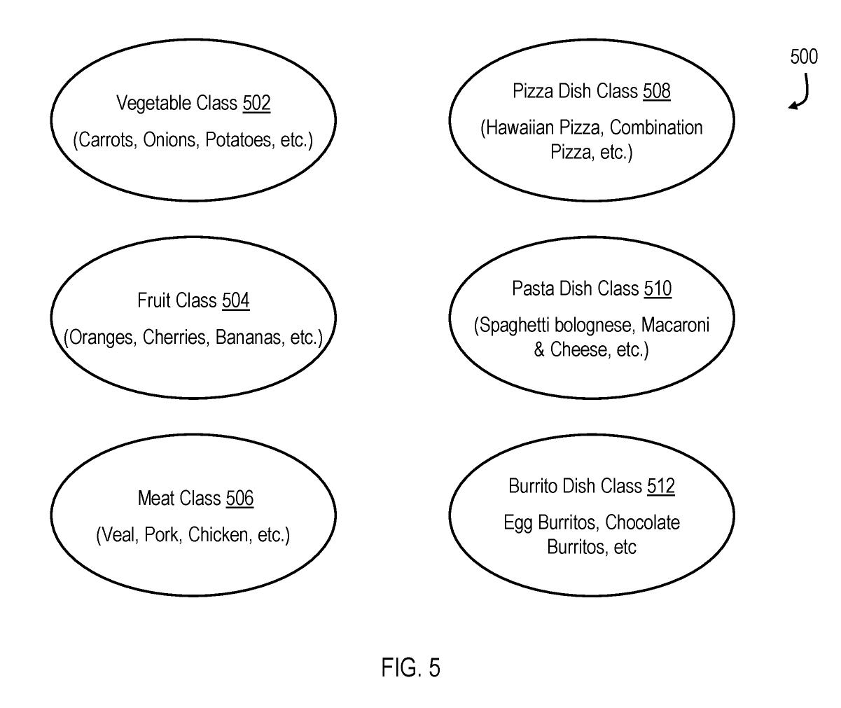

With reference to FIG. 5, a diagram 500 illustrates various exemplary recipe classes. Diagram 500 illustrates a vegetable class 502, a fruit class 504, a meat class 506, a pizza dish class 508, a pasta dish class 510, and a burrito dish class 512. It should be appreciated that the disclosed techniques may implement fewer or more classes. Vegetable class 502 includes vegetables such as carrots, onions, potatoes, etc. Fruit class 504 includes fruits such as oranges, cherries, bananas, etc. Meat class 506 includes meats such as veal, pork, chicken, etc. Pizza dish class 508 includes pasta dishes such as Hawaiian pizza, combination pizza, etc. Pasta dish class 510 includes pasta dishes such as spaghetti bolognese, macaroni & cheese, etc. Burrito dish class 512 includes burrito dishes such as egg burritos, chocolate burritos, etc.

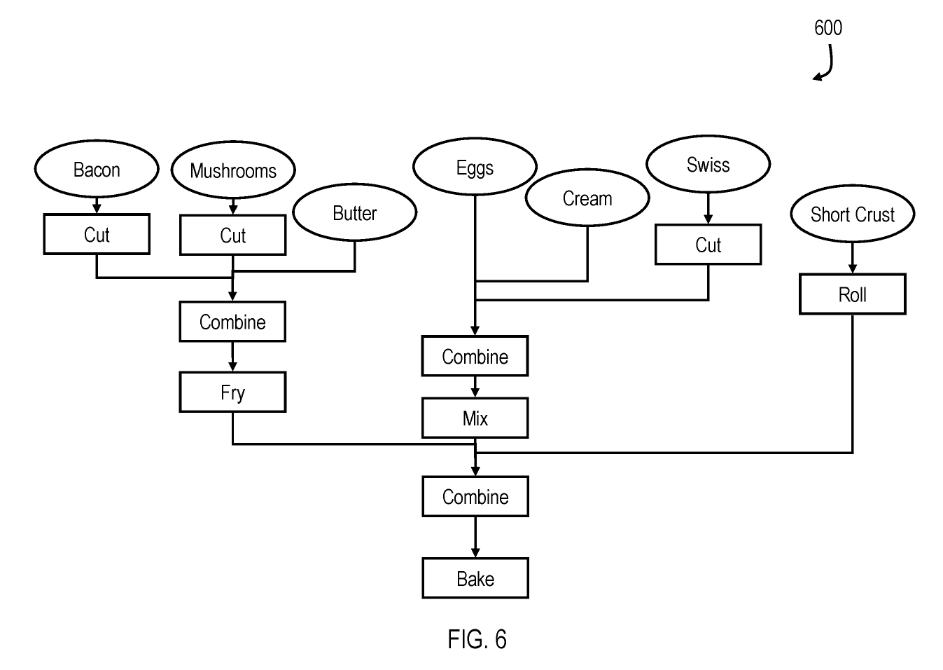

With reference to FIG. 6, an exemplary instruction graph 600 for an existing quiche recipe is illustrated. Instruction graph 600 depicts various ingredients (e.g., bacon, mushrooms, butter, eggs, cream, Swiss cheese, and short crust) in which various operations (e.g., cut, combine fry, mix, roll, and bake) may be performed on appropriate ones of the ingredients. As is illustrated, bacon is cut, mushrooms are cut, and the cut bacon, cut mushrooms, and butter are combined and fried. Swiss cheese is cut, and the cut Swiss cheese is combined with eggs and cream and mixed. Short crust is rolled, and the fried bacon, mushrooms and butter are combined with the mixed eggs, cream, and cut Swiss cheese, with the combination being placed in the rolled short crust (which is formed as a pie crust) and baked. It should be appreciated that each of the recipe steps has an associated time that may be reduced and/or eliminated, depending on the ingredients substituted or omitted. It should also be appreciated that depending on the ingredients substituted or omitted a rating/quality of a resulting quiche may change.

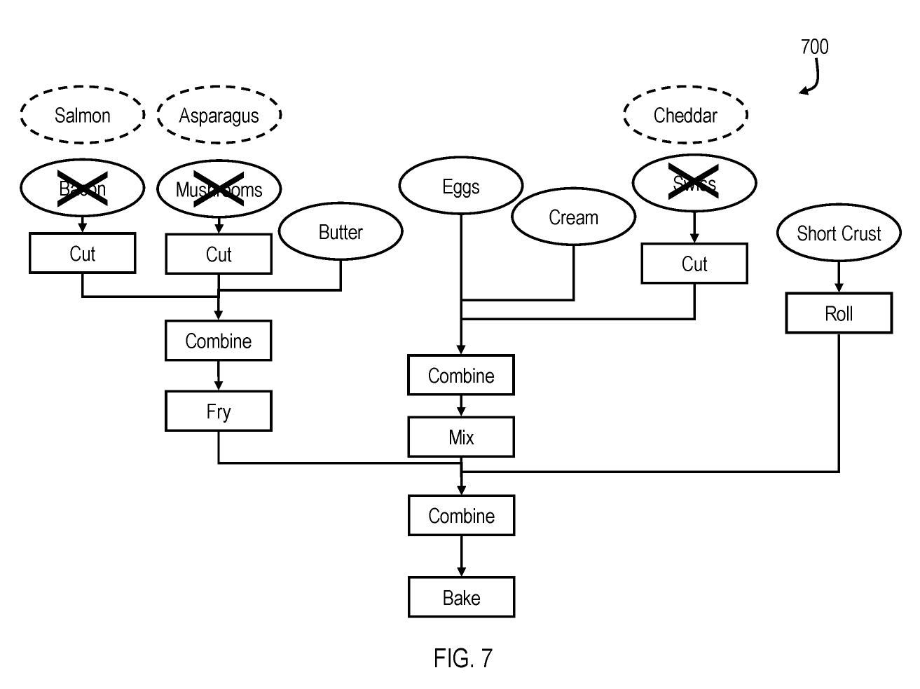

With reference to FIG. 7, an exemplary instruction graph 700 for the quiche recipe of FIG. 6 with various substitute ingredients from a target recipe is illustrated. In instruction graph 700, salmon has been substituted for bacon, asparagus has been substituted for mushrooms, and cheddar cheese has been substituted for Swiss cheese. Based on the substituted ingredients, a preparation time for the quiche of FIG. 7 may be greater than, the same, or less than the preparation time of the quiche of FIG. 6. Similarly, based on the substituted ingredients, a rating/quality for the quiche of FIG. 7 may be higher than, the same as, or lower than the rating/quality of the quiche of FIG. 6.

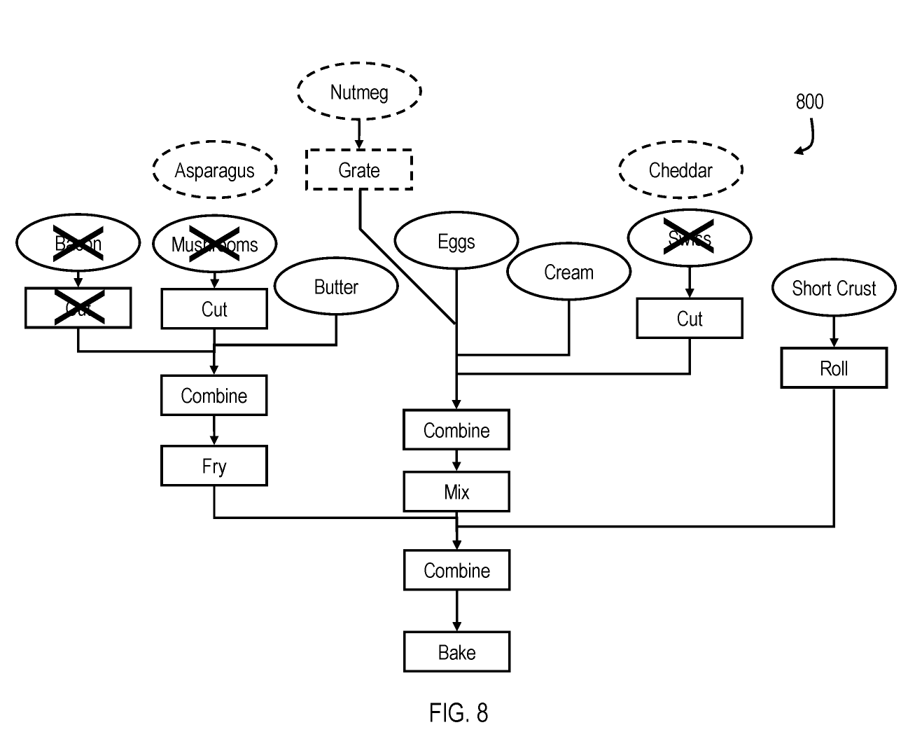

With reference to FIG. 8, an exemplary instruction graph 800 for the quiche recipe of FIG. 6 with various substitute ingredients, a new ingredient, and a deleted ingredient (based on target ingredients from a target recipe) is illustrated. In instruction graph 800, asparagus has been substituted for mushrooms, and cheddar cheese has been substituted for Swiss cheese, nutmeg has been added to the recipe, and bacon has been eliminated from the recipe. It should be appreciated that the cut step for the bacon is no longer required (as the bacon has been omitted from the recipe) and, as such, the preparation time for cutting the bacon can be subtracted from the total preparation time for the recipe. However, a grate step for the nutmeg has been added that increases the total preparation time for the recipe. Based on the substituted ingredients, the added ingredient, and the deleted ingredient, a preparation time for the quiche of FIG. 8 may be greater than, the same as, or less than the preparation time of the quiches of FIGS. 6 and 7. Similarly, based on the substituted ingredients, the added ingredient, and the deleted ingredient, a rating/quality for the quiche of FIG. 8 may be higher than, the same as, or lower than the rating/quality of the quiches of FIGS. 6 and 7.

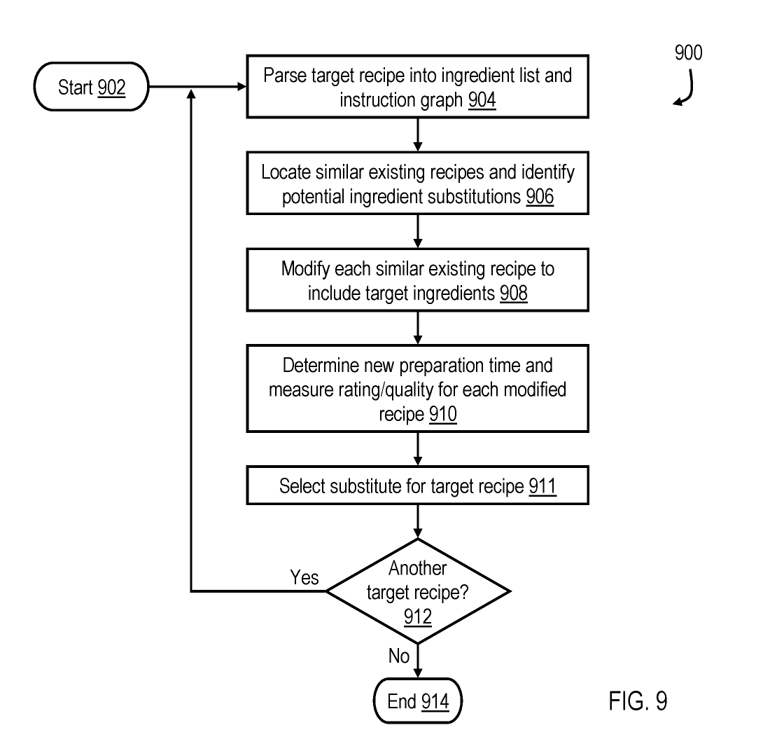

With reference to FIG. 9 a process 900 for modifying existing recipes to reduce preparation times and/or incorporate preferred ingredients from a target recipe, according to aspects of the present disclosure, is illustrated. Process 900 may be implemented, for example, through the execution of one or more program modules (that are configured to function as a recipe analysis engine) by one or more processors 204 of data processing system 200.

Process 900 may, for example, be initiated in block 902 in response to receipt of input by data processing system 200. For example, the input may take the form of a target recipe for which a user wishes to reduce a preparation time and/or incorporate preferred ingredients (i.e., from the target recipe) in one or more other existing recipes. Next, in block 904, data processing system 200 parses the target recipe into recipe components, e.g., an ingredient list and an instruction graph as described above with reference to FIG. 6.

Next, in block 906, data processing system 200 locates similar existing recipes and identifies potential ingredient substitutions based on the target ingredients. For example, the received input may be analyzed to determine various characteristics of the input (e.g., target ingredients and steps associated with the target recipe, dish type, etc.). Based on the analysis, multiple existing candidate recipes similar to the target recipe (as indicated by the received input) may then be selected for loading into L2 cache 206. As noted above, similarity between the target recipe and the candidate recipes may be indicated by the target and candidate recipes being in a same dish type (pizza, pasta, seafood, etc.). Similarity may also be indicated by ingredient distances from the target recipe for each of the existing recipes (or Jaccard similarity coefficients). As above, an ingredient distance may be defined as an edit distance between ingredient sets of two recipes. Then, control transfers from block 906 to block 908, where data processing system 200 modifies each candidate recipe to include the target ingredients. For example, an existing recipe represented in FIG. 6 may be modified to provide candidate recipes represented in FIGS. 7 and 8 based on ingredients in a target recipe. Next, in block 910, data processing system 200 determines modification criteria for each of the modified existing recipes. For example, the modification criteria may correspond to one or more of reduced preparation time, improved quality, ingredient availability, reduced cost, increased rating, higher nutrition, and/or novelty for each candidate modified existing recipe. Then, in block 911, data processing system 200 selects a substitute for the target recipe from among the modified candidate recipes based on the modification criteria.

Next, in decision block 912, data processing system 200 determines whether another target recipe has been received. If another target recipe is received (e.g., within a predetermined time period), control transfers from block 912 to block 904. If another target recipe is not received (e.g., within the predetermined time period), control transfers from block 912 to block 914 where process 900 terminates until a next target recipe is received.

Accordingly, techniques have been disclosed herein that advantageously facilitate modifying recipes to, for example, reduce preparation times and/or incorporate preferred ingredients.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method to modify food recipes, comprising:
parsing, by a data processing system, a target recipe into recipe components;
locating, by the data processing system, existing recipes that are similar to the target recipe;
modifying, by the data processing system, each of the existing recipes to include ingredients of the target recipe;
determining, by the data processing system, respective modification criteria for each of the modified existing recipes; and
selecting, by the data processing system, a substitute recipe for the target recipe from the modified existing recipes based on the respective modification criteria.

2. The method of claim 1, further comprising:
identifying ingredient substitutions for each of the existing recipes that are similar to the target recipe.

3. The method of claim 1, where the recipe components include an ingredient list and an instruction graph.

4. The method of claim 1, wherein the modification criteria includes one or more of reduced preparation time, improved quality, ingredient availability, reduced cost, increased rating, higher nutrition, and novelty.

5. The method of claim 1, wherein the existing recipes that are similar to the target recipe are in a same dish type.

6. The method of claim 1, wherein the locating, by the data processing system, existing recipes that are similar to the target recipe includes:
determining respective ingredient distances from the target recipe for each of the existing recipes to determine similarity.

7. The method of claim 6, wherein the ingredient distances are defined as an edit distance between ingredient sets of two recipes.
